(19) United States
(12) Patent Application Publication
(10) Pub. No.: US 2012/0160645 A1
(43) Pub. Date: Jun. 28, 2012

(54) SWITCH FOR VEHICLES

(75) Inventors: Mauro Zorzetto, Casle Monferrato (IT); Alberto Barbano, San Germano Monferrato (IT); Andrea Daffonchio, Alessandria (IT); Costanzo Gadini, Frassineto Po (IT)

(73) Assignee: ELTEK S.P.A., Casale Monferrato (AL) (IT)

(21) Appl. No.: 13/379,774

(22) PCT Filed: Jul. 5, 2010
(86) PCT No.: PCT/IB2010/053082

§ 371 Date: Jan. 18, 2012

(30) Foreign Application Priority Data
Jul. 7, 2009 (IT) TO2009A000508

(51) Int. Cl. H01H 3/02

(52) U.S. Cl. 200/329

(57) ABSTRACT

A switch for vehicles, in particular of the type adapted to be actuated by a linkage or kinematic system of the vehicle, used for signaling an operating condition, includes: a body, electric terminals housed within the body, an actuation element at least partly movable within the body when subjected to a control action, so as to put at least two of the electric terminals in electric contact with each other, wherein the actuation element is at least partly deformable when a higher stress is applied thereto than necessary for closing the contact between the electric terminals.

The present invention relates to an electric switch or contact for vehicles, such as a push-button, in particular of the type adapted to be actuated by the movement of a linkage or control element of the vehicle for signaling a status condition of the latter, e.g. a gear selector lever or a brake pedal. Such switches normally comprise a slider partly protruding from a switch body and movable within a seat defined inside the switch body itself in order to open or close an electric contact between electric terminals also housed in the switch body.

The slider is generally a part of an actuation element which moves when the slider is subjected to an axial stress transmitted by the linkage whose status condition must be signaled.

When the switch is used for signaling when a vehicle is put into reverse gear, it is typically installed inside the gearbox, and the slider is acted upon by the gear selector lever: when the latter is moved to the reverse position, the contact between the electric terminals is closed and the reverse lights are turned on.

In some prior-art designs, the actuation element also comprises a diaphragm placed between the slider and the body portion that houses the electric contacts, so that the latter are protected from dust and dirt, which might otherwise get into the body and impair the contact quality.

One problem encountered with this type of switches is that they typically require the use of a compensation device to prevent the switch from suffering damage in the event that the slider is stressed by the linkage past the position corresponding to the closing of the contact between the electric terminals.

Such a condition occurs quite frequently in switches of this kind, because the linkage is moved manually by a user who, depending on the situation, may force it beyond the ideal position (at which there is electric contact between the terminals).

This forcing may cause damage to the switch.

In some known solutions, this problem is tackled by using a metal coil spring (typically made of harmonic steel) associated with the slider, which absorbs any stresses possibly caused by the user forcing the linkage: in practice, the slider is divided into two coaxial parts, i.e. a first part moved by the linkage and a second part associated with the electric terminals; between the two parts there is a spring, so that, if the slider is forced, the first part will move relative to the other part, thereby avoiding any damage to the switch.

In fact, when the second part has arrived at its end of travel (electric terminals in contact with each other), any additional stress transmitted to the first part by the linkage will have it translate without transmitting the movement to the second part, due to the spring being compressed.

Although valid in principle, this solution is however quite complex and costly. In the first place, it is necessary to prearrange a slider divided into two coaxial parts between which a spring having an appropriate tensile modulus is interposed; in particular, the latter is a coil spring calibrated in a manner such that it will not compress axially under a first compression force or first displacement of the slider in order to transmit the motion to the electric contact, and that it will compress axially when the slider is subjected to a second higher force or displacement, in order to not transmit any further motion.

In the second place, a very accurate machining of the coupling surfaces between the two parts of the slider and between the latter and the spring is required, in particular in order to avoid any risk of seizure or excessive play which would prevent the switch from operating properly, and/or to avoid that the sum of all the single dimensional tolerances of the plurality of parts may cause anomalous operating conditions, and/or anomalous variations in the predefined value of said calibrated force, i.e. of said first and/or second forces. In addition, the harmonic steel spring and the two-part construction of the slider are typically quite costly, and this design requires an additional cost for assembling the various parts, so that the switch turns out to be relatively expensive to produce.

A further factor to be taken into account is that the switch production and assembly step is rather problematical, since the spring is normally slightly recompressed before being inserted between the two parts of the slider, in particular for the purpose of predefining the value of said calibration force. The object of the present invention is to overcome the above-mentioned drawbacks.

In particular, it is an object of the present invention to provide a switch fitted with a simple and low-cost compensation device.

It is a further object to provide a switch of the above-mentioned type wherein the actuation element is easy to produce and is made up of a minimal number of parts.

It is a further object to provide such a switch which is easily assembleable.

It is yet another object to provide a switch offering increased reliability.

In a preferred solution, the switch has the features set out in the first claim.

Further advantageous features will be set out in the appended claims, which are intended as an integral part of the present description.

An idea at the basis of the present invention is to provide a switch fitted with a movable actuation element, e.g. a sliding or linearly moving actuation element, capable of deforming at least partially, preferably being adapted to expand or deform at least partially in at least one transversal or radial direction relative to the moving or sliding direction; in particular, the actuation element is so shaped as to generate a deformation in at least one section thereof when subjected to a stress which would otherwise move it past the position corresponding to the closing of the contact between the electric terminals, thereby limiting the force discharged onto the latter by the actuation element.

Another idea at the basis of the present invention is to provide a switch fitted with an actuation element comprising at least one elastic or deformable element adapted to be moulded, such as a thermoplastic elastomer material, i.e. of the type suitable for being injected and/or formed in a mould.

A further idea at the basis of the present invention is to provide a switch fitted with a movable actuation element made as one piece, in particular of the type having an elastic or deformable element made in one piece with the actuation element.

Yet another idea at the basis of the present invention is to provide a switch fitted with a movable actuation element comprising at least one elastic or deformable element made of elastomer material.

These features as well as further advantages of the present invention will become apparent from the following description of an embodiment thereof as shown in the annexed drawings, which are supplied by way of non-limiting example, wherein:

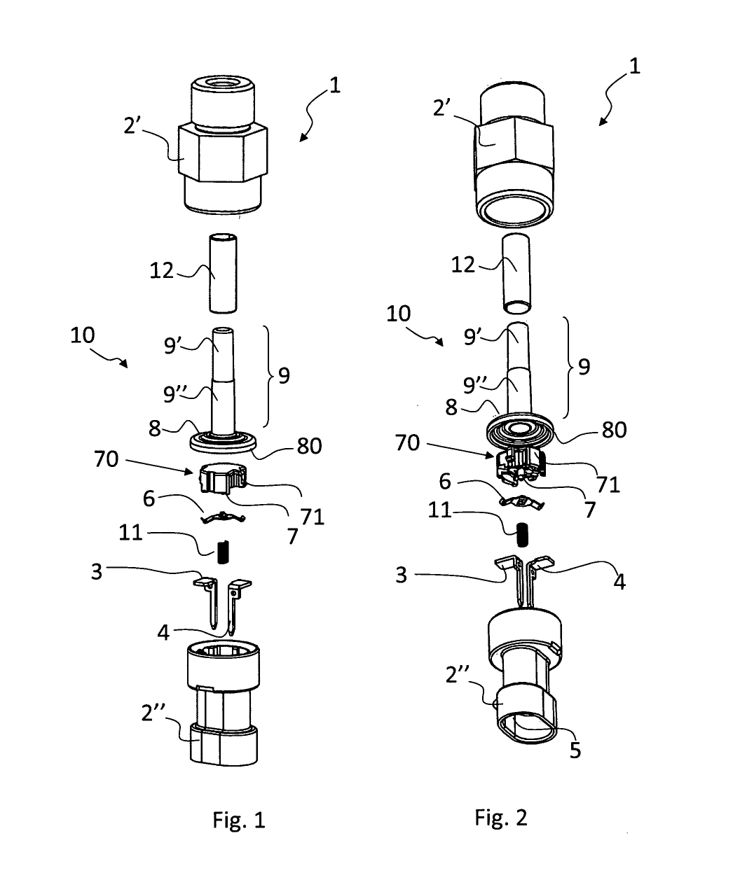

FIGS. 1 and 2 are two different exploded perspective views of the switch according to the present invention;

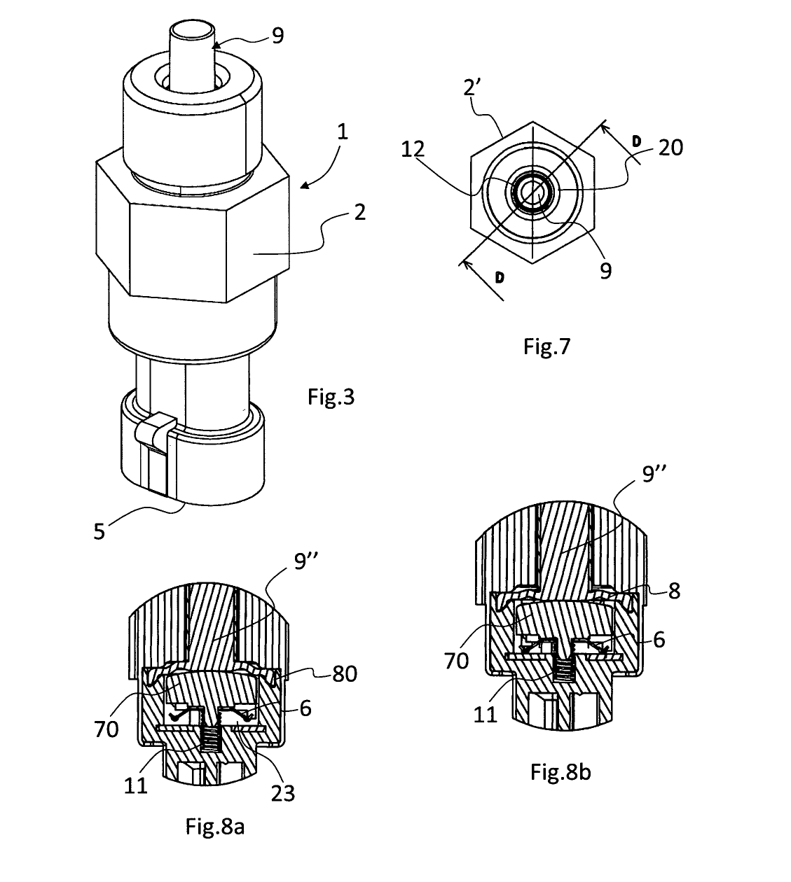

FIG. 3 is a perspective view of the switch of FIG. 1 in the assembled condition;

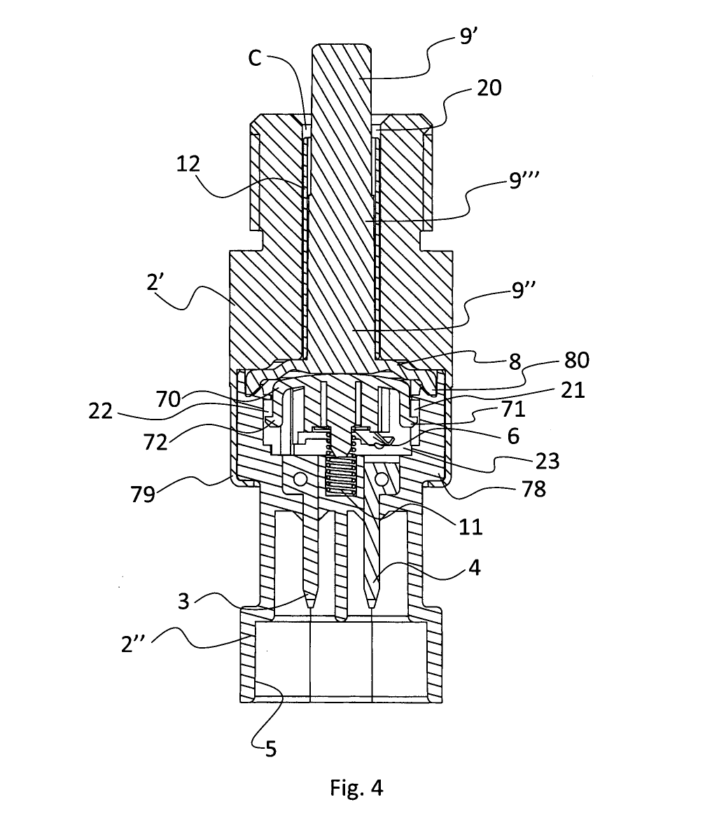

FIGS. 4, 5 and 6 are respective sectional views of the switch of FIG. 3 in different operating conditions;

FIG. 7 is a top view of the switch of FIG. 3;

FIGS. 8a, 8b are sectional views along line D-D of FIG. 7 of a detail of the preceding switch in respective operating conditions;

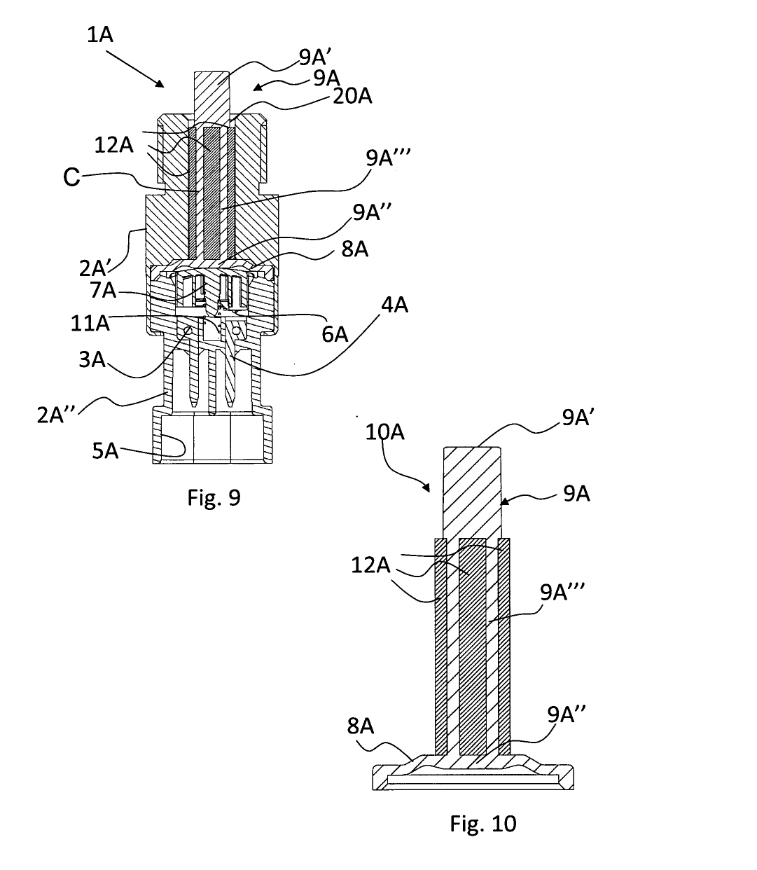

FIG. 9 is a sectional view of a first variant of the switch of FIG. 3;

FIG. 10 shows a detail of FIG. 9;

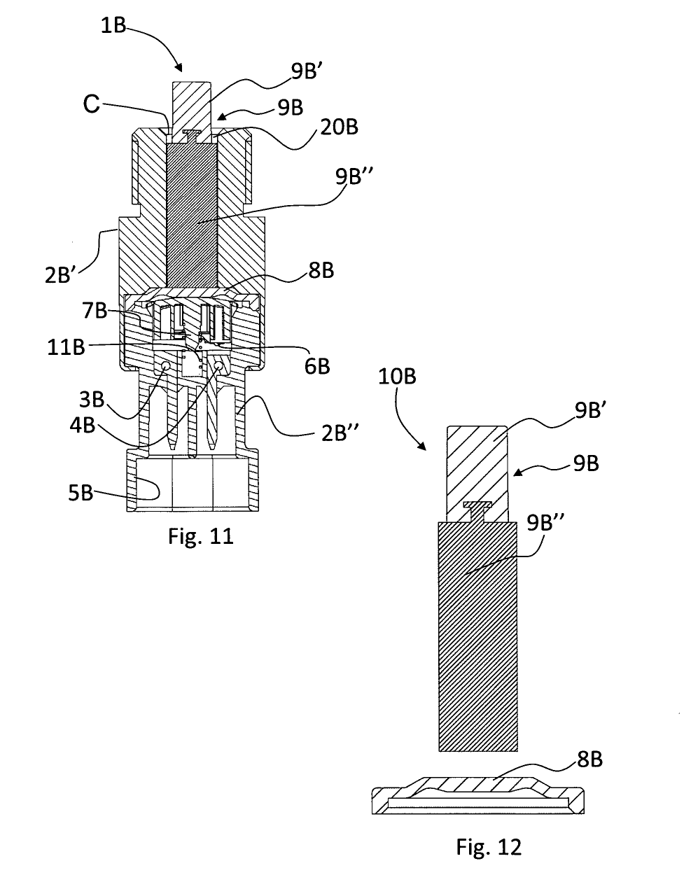

FIG. 11 is a sectional view of a second variant of the switch of FIG. 3;

FIG. 12 shows a detail of FIG. 11;

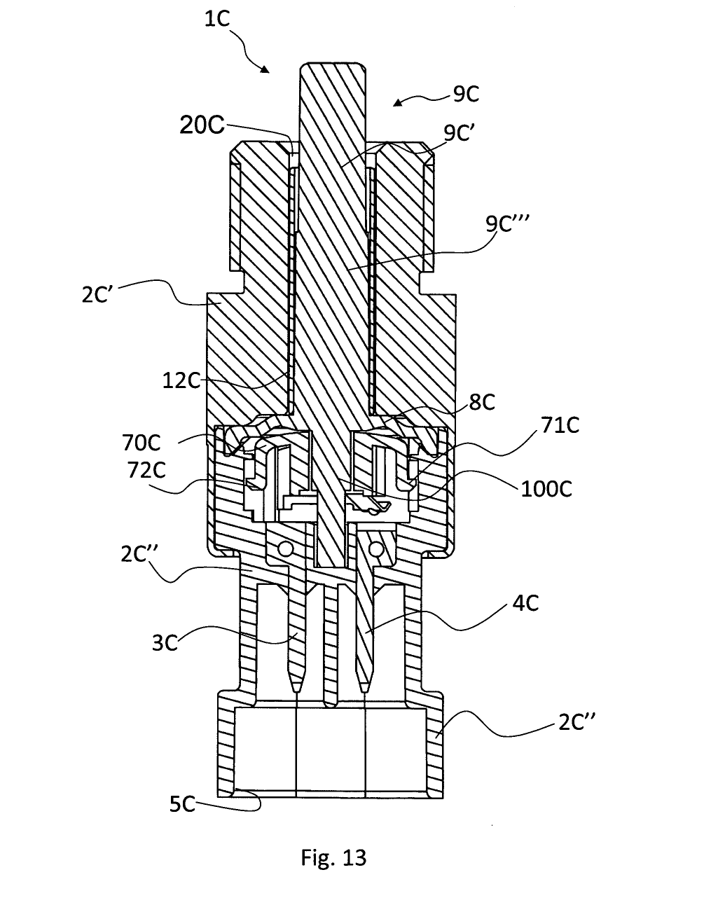

FIG. 13 is a longitudinal sectional view of a third variant of the switch according to the invention;

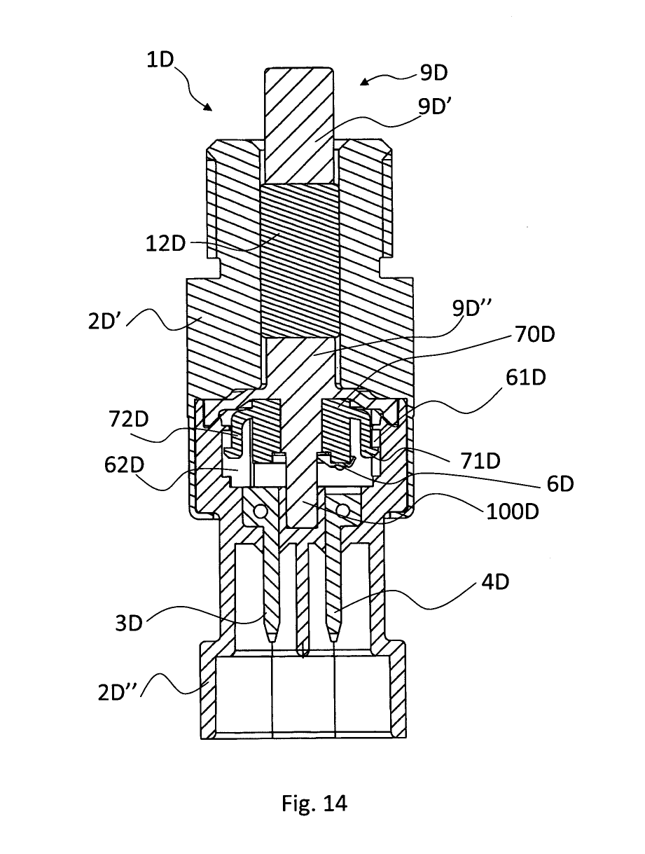

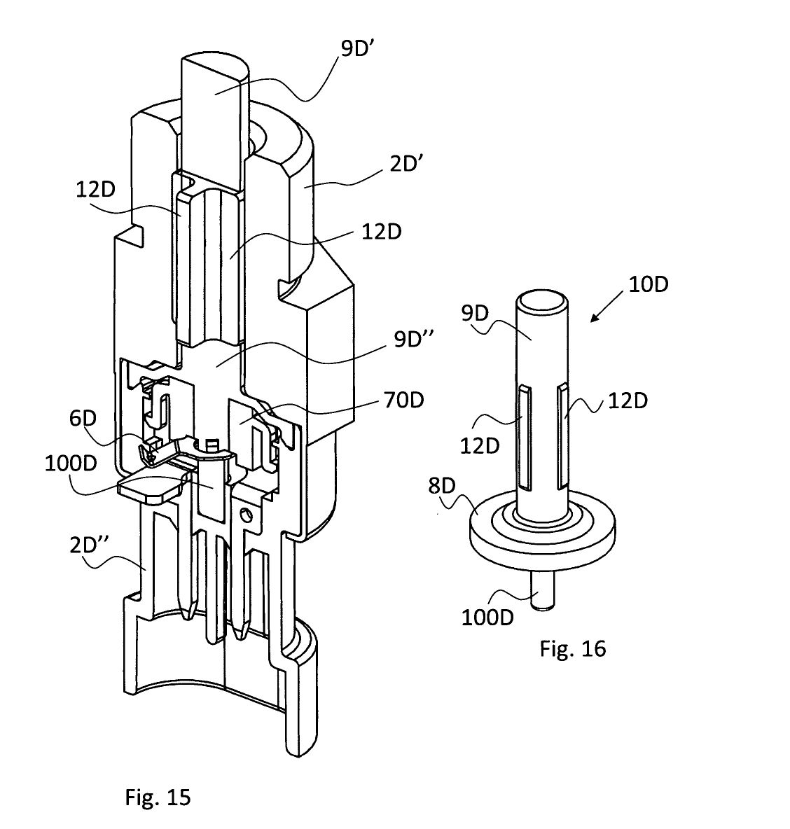

FIGS. 14 and 15 respectively show a longitudinal sectional view and an axonometric view of a fourth variant of the invention, with a part thereof removed;

FIG. 16 shows a detail of the switch of FIGS. 14 and 15;

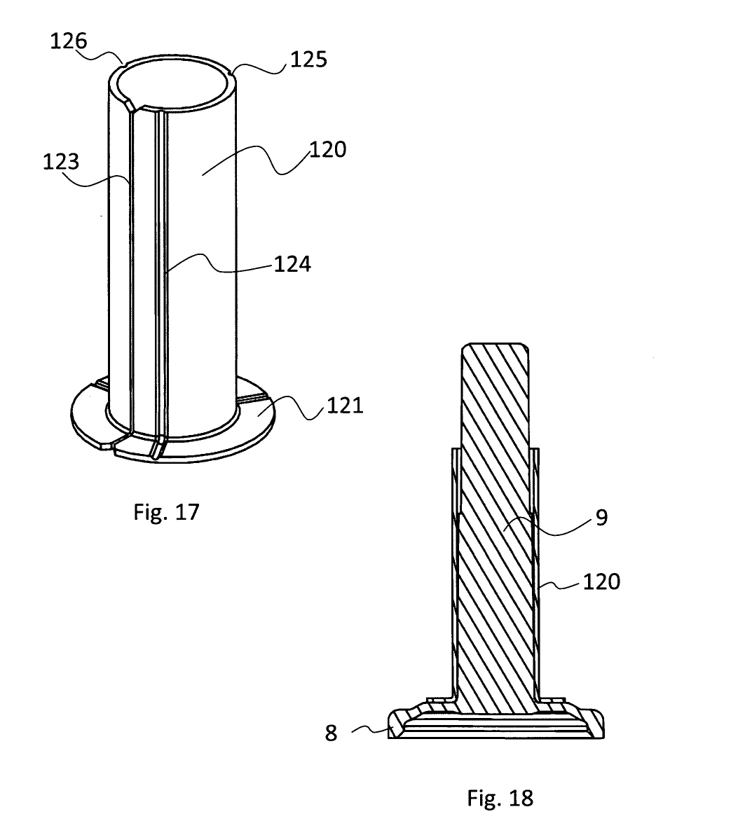

FIG. 17 shows an alternative embodiment of a detail of the switch of FIG. 1-8;

FIG. 18 is a longitudinal sectional view of the detail of FIG. 17 when applied to the actuation element of the switch of FIG. 1-8.

Referring now to FIGS. 1 to 8, there is shown a first embodiment of the switch 1 according to the present invention.

This may be, for example, a switch for vehicles, in particular of the type adapted to be installed in a vehicle's gearbox or to be actuated by moving a vehicle's gear selector lever in order to turn on/off the reverse light. Alternatively, and without being limited thereto, it may be a switch adapted to control the vehicle's brake lights; in such a case it will be actuated by the brake pedal.

The switch 1 comprises a body 2, consisting in this example of two half-bodies or half-shells 2′ and 2″ assembleable together and housing two electric terminals 3 and 4, which protrude into a mouth 5 for a connector, such as a plug or a socket (not shown), connected to the electric wires that carry the signal to a control unit of the vehicle or to an electromagnetic switch or directly to the lights.

The two electric terminals 3 and 4 are put in a condition of electric contact by the contact bridge 6, when the latter is pushed downwards by a thrust element or pin 7.

According to a preferred embodiment, the latter is a central portion or core of a movable insert 70, such as a rigid insert having a substantially bell-like shape, housed in the lower half-shell 2″ of the switch body.

Said contact bridge 6 is preferably secured or hooked to said insert 70 or thrust pin 7, while still being elastic or partially free to move; the thrust insert 70 is preferably so shaped as to create a positioning seat or mounting portion for one end of an elastic element or spring 11, the other end of said spring 11 being housed in a positioning and/or mounting seat 19 of the half-shell 2″.

The insert 70 has two diametrically opposed appendices 71, 72 which protrude slightly to engage respective grooves 21, 22 provided in a seat 23 formed within the lower half-shell 2″: the grooves 21, 22, when engaged by the appendices 71, 72, guide the axial movement of the insert 70, thereby ensuring a balanced action upon the contact bridge 6; in addition, the appendices 71,72 are used for coupling the insert 70 to the body 2″, in particular for the purpose of facilitating the assembly and/or manipulation of a portion of the switch.

Said appendices 71, 72 or other parts of the insert 70 may also be shaped in a manner such as to provide mechanical catches or end-of-travel stoppers, in particular for the purpose of limiting any excessive thrust on the contact bridge 6.

The latter is preferably a metallic and/or elastic one, in particular in order to appropriately adapt its electric contact position to that of the respective electric terminals 3 and 4.

The insert 70 with the thrust pin 7 is moved towards the electric terminals 3 and 4 by an actuation element 10, which in this example comprises a diaphragm 8 associated with a linear slider 9.

In particular, in this case the slider 9 slides within the body 2 under a force exerted axially, e.g. when the gear selector or brake linkage is moved.

The movement of the slider 9 towards the electric terminals 3 and 4 causes the diaphragm 8 to undergo a corresponding deformation and push the insert 70, the thrust pin 7 and the bridge 6 towards the electric terminals 3 and 4, which are thus put in a condition of electric contact; at the same time, the return spring 11 is compressed between the thrust pin 7 and the body 2.

After the axial stress has been exerted on the slider 9, the latter slides back away from the electric terminals 3 and 4 through the effect of the elastic return of the return spring 11.

It should be pointed out that in the example shown herein the slider 9 has a portion surrounded by a limiting cylinder 12, the function of which will be explained later on.

In this example, the slider 9 has two opposite end portions: one free end portion 9′ and one end portion 9″ associated with the diaphragm 8.

With specific reference to the example shown by way of example in FIGS. 1 to 8, the slider 9 is wholly made of elastomer, e.g. rubber or a thermoplastic and/or mouldable elastomer or the like, and is made in one piece with the diaphragm 8, which is therefore made of the same material.

The main function of the diaphragm is to insulate from dust and dirt the inside of the half-shell 2″ that houses the electric terminals 3 and 4, while still allowing the transmission of motion from the slider 9 to the thrust pin 7 and vice versa.

In this regard, it must be stressed that the diaphragm 8 is located at the interface between the first and the second half-shells 2′ and 2″ so as to insulate the latter, which houses the electric terminals 3 and 4.

In particular, the diaphragm 8 is provided with a peripheral portion 80 similar to a sealing ring, e.g. shaped like an O-ring, which is used as a suitable sealing element to be compressed between the two half-shells 2′ and 2″ during the assembly stage.

In order to retain said assembly and/or sealing position, the half-shell 2′, which is preferably made of a metallic material, has an end portion 79 adapted to become deformed and provide a mechanical seal against the portion 78 of the body 2″, which is preferably made of an insulating thermoplastic material, as shown in FIG. 4.

Referring back to the slider 9, FIG. 4 shows that it also comprises a central portion 9′″ arranged between the two end portions 9′ and 9″ previously mentioned.

It should be noted that the free end portion 9′, i.e. the one farthest from the electric terminals 3 and 4 projecting out of the half-shell 2′, has a slightly truncated-cone shape, i.e. it has an at least partly reduced diameter.

The switch 1 advantageously comprises rigid limiting means adapted to limit the transversal expansion of at least a portion of the slider 9 located at the slide guide or seat 20.

In the example of FIGS. 1-8, such limiting means consist of a limiting cylinder 12 extending over the central portion 9′″ (which has a constant diameter) and over at least a certain length of the free end portion 9′ of the slider 9.

The latter being a truncated cone, between it and the limiting cylinder 12 an empty space is formed, which provides an expansion chamber C.

The slider 9 slides to and from the electric terminals within a slide guide 20 defined, in the illustrated example, by the walls of the body 2′; preferably, the slide guide 20 has dimensions and a shape corresponding or close to those of the slider 9, so as to promote the sliding action thereof while reducing the infiltration of dust and dirt into the half-shell; in particular, it has the same shape as the central portion 9′″ of the slider 9, and its size is slightly bigger. It must be stressed that, advantageously, between the slider 9 and the slide guide 20 there is a lubricant, such as the gearbox lubricant, which promotes the relative sliding action thereof.

For this purpose, the materials used for manufacturing at least some of the components of the device 1, in particular the material or elastomer of the slider 9, are suitable for use in contact with such lubricants or oils.

In particular, the material of the actuation element 9 is silicone or thermoplastic rubber with hardness between 30 ShA (Shore A) and 100 ShA, preferably silicone with hardness between 50 ShA and 80 ShA or thermoplastic rubber with hardness between 50 ShA and 90 ShA.

In order to understand the operation of the switch and the function of the expansion chamber C and of the limiting cylinder 12, it is useful to refer to FIGS. 4-6, which show three operating conditions of the switch.

Beginning with FIG. 4, it shows the switch in the idle condition: no stress is applied to the slider 9, which is therefore in the idle position, with the return spring 11 fully extended and the slider 9 partly protruding from the shell 2; the thrust pin 7 is far from the electric contacts 3 and 4, and therefore the metallic bridge 6 does not close the circuit.

When the linkage associated with the switch 1 is shifted (e.g. when the reverse gear is engaged or the brake pedal is pressed), it presses against the free portion 9′ of the slider 9, thereby causing an axial movement of the latter towards the electric terminals 3 and 4.

Due to the geometry of the various parts, the axial movement of the slider 9 causes it to slide within the slide guide 20 towards the terminals 3 and 4.

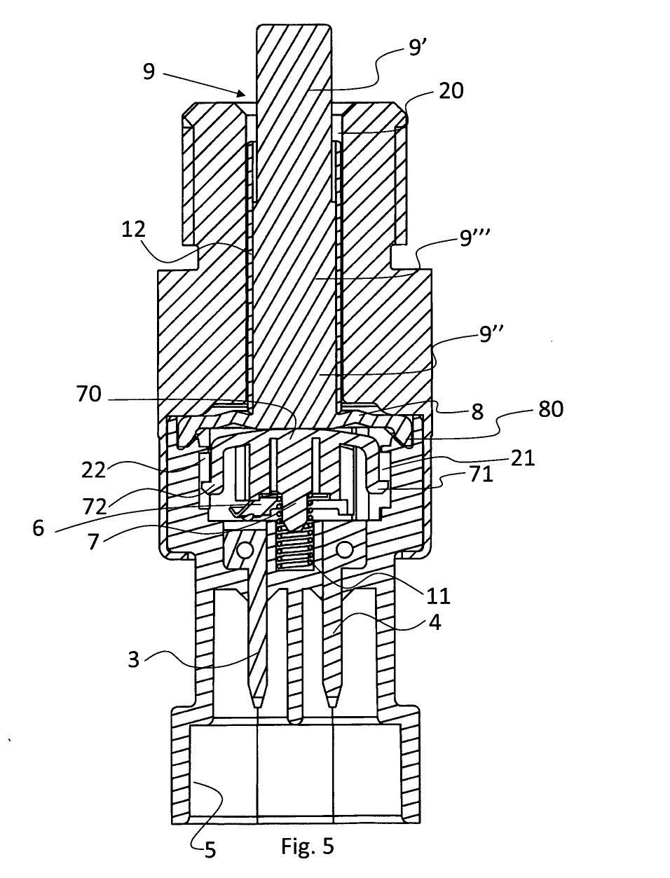

FIG. 5 illustrates this situation when the displacement of the slider 9 is sufficient to have the bridge 6 abut against the electric terminals 3 and 4.

During the shift from the position of FIG. 4 to the position of FIG. 5, the limiting cylinder 12 slides within the slide guide 20 to facilitate this operation and prevent the two parts from seizing or generating excessive friction: in fact, the limiting cylinder 12 is made of metal or hard plastic, and its coefficient of friction against the slide guide 20 is rather low, so that the relative movement between the two parts is not hindered.

In particular, the limiting cylinder 12 may be made of a metal among ferrous metals, steel, brass, copper, aluminium or alloys thereof, preferably a metal identified as AISI304; in particular a metallic material which can be easily machined in order to make said cylinder, which may be obtained by using a thin sheet appropriately wound and/or formed or moulded, or by means of extrusion or drawing processes.

If the limiting cylinder 12 is made of a thermoplastic material, it is in particular preferable to use polyamide (PA) or polyparaphenylene sulphide (PPS), possibly charged or added with suitable reinforcement materials or fibres, such as fibreglass; preferably fibreglass-charged PA66.

The limiting cylinder 12 also provides a further function: it prevents the slider 9 from becoming deformed in its central portion transversally to its sliding direction due to the stress applied to its free end 9′, thus allowing it to slide unhindered.

Since the slider 9 is made of elastomer, a force applied to its free end 9′ might deform it radially in the region thereof facing the slide guide 20, thus preventing it from sliding smoothly.

Therefore, if the displacement of the slider equals the one required for closing the contact between the electric terminals 3 and 4, the slider 9 will stay substantially undeformed, and in any case any small deformation will be absorbed or limited by the expansion chamber C without hindering the movement.

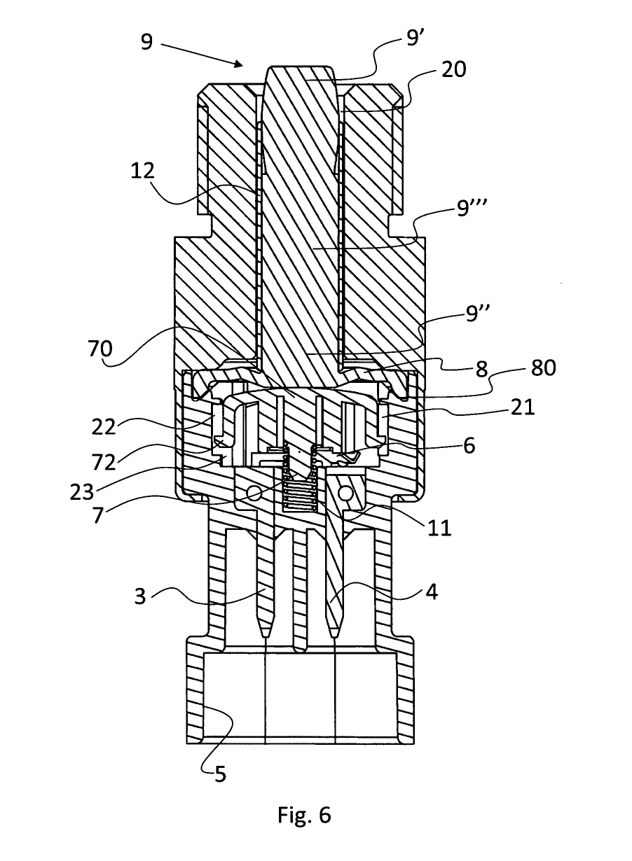

FIG. 6 shows a situation in which the linkage associated with the slider 9 stresses the latter further towards the terminals 3 and 4 when the electric contact between the two has already been established.

In practice, this is the situation that is encountered whenever further stresses are applied in addition to the condition shown in FIG. 5, e.g. when the user forces the linkage past the ideal position.

In this case, in order to prevent any damage to the switch 1, the function of the compensation device is performed primarily by the elastomer portion of the slider 9 which is not confined by the limiting cylinder 12: in fact, when the bridge 6 is abutted against the electric terminals 3 and 4, i.e. when the insert 70 is resting on the body or half-shell 2″, the slider 9 is not allowed to translate any further in that direction in order to avoid damaging the switch 1.

In this case, the portion 9′ and/or that part of the portion 9′″ that faces the expansion chamber C will expand radially, thereby absorbing the stress applied to the slider 9, which will become shorter and expand transversally to the sliding direction, as clearly shown in FIG. 6.

In this respect, it is worth mentioning right away one possible variant of the above-described example: the deformation, which in the latter occurs in the form of outward radial expansion, i.e. toward the walls of the guide 20, may also take place in a different way.

For example, it is conceivable to provide a movable element, such as a slider, having partially hollow elastomeric parts which can inflect at least partially inwards when subjected to an axial stress.

According to another variant not shown in the drawings, for example, the elastomer in use is of the type commonly called “foam”, wherein cavities (such as air bubbles) are incorporated into the elastomer matrix: in this case, at least a part of the deformation may be absorbed by the cavities, thus reducing or limiting the radial expansion.

At any rate, the resulting deformation of the slider 9 allows to absorb the effect of any excessive or wrong manoeuvres made by the user, with the advantage that an extremely cheap switch can be produced in which there is no metal-spring compensation device and the slider 9 is preferably monolithic, leading to easier steps of assembling and reducing the components of the switch 1.

According to a preferred embodiment, at least a portion of the slider 9 or of the actuation element 10, in particular at least one of said portions or ends 9′, 9″, 9′″, comprises at least a portion having a prismatic or cylindrical shape wholly made of elastic deformable material, i.e. a material capable of returning to its original shape after having being stressed, such as an elastomer; alternatively, cavities may also be provided within said prismatic or cylindrical portions.

Preferably, the shape and the material of the slider 9 or of the actuation element 10, and in particular of at least one of said portions or ends 9′, 9″, 9′″, is such that they will not deform under an axial thrust of a first force F1, while deforming at least partly under an axial thrust of a second force F2. Said first force F1 being however adapted to move said slider 9 or actuation element 10 of the switch 1.

The limiting cylinder 12 may be coupled to the slider 9 integral therewith by simply forcing the latter into the former, thus simplifying the assembly stage; it is however possible to conceive different coupling steps, e.g. by glueing or welding or engaging or moulding the material of the slider 9 onto the cylinder 12.

The limiting cylinder 12 may advantageously have such a profile that prevents any damage to the slider 9 and/or to the diaphragm 8, e.g. a profile rounded at least at its end, as will be described more in detail below.

There is yet another advantage that must be pointed out: as clearly shown in FIG. 6, the free end 9′ of the slider can become deformed until it comes in contact with the fixed walls of the body, thus interfering therewith and countering the axial thrust.

It is important to note that the expansion chamber C is optional, in that the above-described functions may alternatively be provided by sizing the parts appropriately.

A further advantage must be stressed: in the example discussed above the diaphragm 8 is made in one piece with the slider 9 through a single moulding step, thereby cutting down the costs and further simplifying the assembly.

Of course, it must be pointed out that the above is to be understood as a non-limiting example, and therefore the slider having a circular cross-section may equivalently be replaced by a slider having any other cross-section, e.g. square, oval, rectangular or the like.

Likewise, the number of electric terminals may be different, e.g. there may be three, four or more terminals put in a condition of electric contact by the bridge 6, which in turn may have different shapes, just like the thrust pin 7, which may have any geometry or even be missing (being replaced, for example, by a suitable profile integral with the diaphragm).

As a first variant, the one shown in FIGS. 9 and 10 will now be described: in this case, the drawings illustrate a switch 1A wherein the same reference numerals, followed by the letter “A”, designate components equivalent to the corresponding components of the above-described switch 1.

This variant differs from the one illustrated previously in that the actuation element 10A comprises, as a movable element, the slider 9A, which features rigid limiting means consisting of the rigid radial ribs 12A.

If the limiting means 12A are made of a thermoplastic material, it is in particular preferable to use polyamide (PA) or polyparaphenylene sulphide (PPS), possibly charged or added with suitable reinforcement materials or fibres, such as fibreglass; preferably fibreglass-charged PA66.

If the limiting means 12A are made of a metallic material, the latter is preferably a metallic material which can be easily machined or moulded into complex shapes, e.g. by die casting or sintering or drawing or hot pressing, such as a metal among ferrous materials, steel, brass, copper, aluminium or alloys thereof.

The rigid radial ribs 12A extend at least over the central portion 9A′″ of the slider 9A and protrude outwards from the elastomer material making up the latter: the slide guide 20A within the body 2A is sized in a manner such that the radial ribs 12A are internally tangential to the slide guide along lines parallel to the sliding direction of the slider 9A when the latter is moving.

Thus, the aforementioned expansion chamber C is generated within the space between two adjacent ribs 12A and the slide guide 20A obtained in the body, with substantially the same effects: as long as the slider 9A is translating, any deformation thereof in a direction transversal to the direction of motion is absorbed by said expansion chamber without hindering the motion.

When the slider 9A is abutted (i.e. when the metallic bridge 6A has come in contact with the electric terminals 3A and 4A), any additional stress towards the electric terminals 3A and 4A causes a deformation, in a direction substantially transversal to the direction of motion, of the free portion 9A′ which does not include the ribs 12A, with the same advantageous effects already described.

It is also conceivable that at least one radial rib 12A extends substantially to the centre or axis of the slider 9A, thus creating a rigid core or internal reinforcement that counters the compression of the elastomer of the portion 9A′″.

In this manner, in fact, the elastomer portion 9A′″, although not confined in its perimetric portion near the guide 20A, is not subject to particular deformation stresses, resulting in smaller dimensional variations in the radial direction.

The end portion 9A′, on the other hand, preferably lacks said reinforcement core, so as to be able to deform and compensate for any excessive thrusts.

Said rigid limiting means with the radial ribs 12A may, as an alternative, be shaped as a “solid” cylindrical element provided with internal axial passages used for placing the elastomer materials moulded at the two axial ends in communication with each other, thus making the elastomer integral with the rigid body; the internal passages also allow the material to be injected from one axial end only, i.e. from one side of the mould, and then flow to the opposite end of the part.

Alternatively, a rigid limiting element 12A may include perimetric reliefs, or may comprise a perimetric or tubular rigid element, connected to a rigid central core through rigid radial elements, while still featuring axial passages 9A′″ placing the two axial ends in communication with each other; said passages 9A′″ being in particular adapted to be filled with an elastomer material during a step of overmoulding said rigid element 12A, for the purpose of connecting, through elastomer, the two ends 9A′ and 9A″ made of elastomer, i.e. for the purpose of creating a single overmoulded elastomeric part provided with elements 9A′″ for securing it to the rigid limiting element 12A.

A second variant is shown in FIGS. 11 and 12, wherein the same reference numerals, followed by the letter “B”, designate components equivalent to those of the above-described switch 1.

In this variant, the actuation element 10B comprises, as a movable element, the partially elastomeric slider 9B, which features a first elastomeric portion 9B′ and a second portion 9B″ made of a rigid material (such as metal or hard plastic).

In this solution, the diaphragm 8B is not in one piece with the slider 9B, being manufactured separately and then mounted thereon; it may however be overmoulded.

As can be seen, the second rigid portion 9B″ of the slider 9B has dimensions substantially close to those of the slide guide 20B obtained in the body, whereas the first elastomeric portion 9B′ has significantly smaller dimensions; the expansion chamber C is thus formed between these two components.

In this case, advantageously, when the slider 9B is translating, any deformation thereof in a direction transversal to the direction of motion is absorbed by the distance between it and the walls of the housing seat, or because a large portion thereof is located outside the switch, so that its motion is not hindered.

When on the contrary the slider 9B is abutted (i.e. when the metallic bridge 6B has come in contact with the electric terminals 3 and 4), any additional axial stress causes a deformation in a direction substantially transversal to the direction of motion of the elastomeric portion 9B′, resulting in the same advantageous effects described above.

Although in the examples previously described and illustrated reference has been made to an actuation element comprising a slider moving linearly within the switch body, it is understood that such solutions are to be intended as mere non-limiting examples of the idea at the basis of the present invention.

In a more general sense, in fact, the movable slider may be adapted to move not only linearly, but also angularly, e.g. it may be a rotary element.

In this regard, the actuation element may be configured as an angular lever at least partly made of elastomer: in such a case, it would be conceivable to provide an L-shaped lever moving rigidly until the electric terminals are closed, and then deforming or bending as the stress persists.

Another possible variant should also be taken into account, which employs an actuation element (of the type comprising a linear or angular slider) in which, instead of the portion made of elastomeric material, there is a deformable region, e.g. made of a thermoplastic material relatively rigid when thick and elastic when thin or appropriately shaped.

In this respect, the slider 9 may, for example, be wholly made of a rigid material, e.g. PA66 (nylon), and include an end portion 9′ which is thinner and/or so shaped as to be at least partly deformable.

In this case as well, the deformation may develop in different directions, as previously discussed.

According to a further possible variant of the invention, shown in FIG. 13, wherein the same reference numerals, followed by the letter “C”, designate components equivalent to those of the above-described switch 1, the switch spring may be omitted, i.e. replaced by the elasticity of the actuation element itself, which may be suitably shaped for this purpose.

In this case, the actuation element 10C has one end 100C jutting out from the side of the diaphragm 8C and passing through the insert 70C: differently from the previous examples, the latter is open at the top and lacks the central pin (7 in FIGS. 1 and 2).

It should however be taken into account that a similar function could be carried out by an actuation element 9C shaped in a different manner and/or by another part; for example, by an actuation element with a jutting end 100C having a different shape, such as a perimetric jutting end external to the insert 70C (not shown); as an alternative, the diaphragm 8C itself may be shaped appropriately to provide the elasticity necessary for returning the movable contact bridge 6 to its initial position.

The end 100C then extends past the insert 70C along the central axis of the switch, down to the lower half-shell 2C″: it is therefore so shaped as to provide the elastic means for resetting the electric contact, as a substitute for the spring 11 of the preceding examples.

For this purpose, the end 100C is at least partly made of elastomer material; in addition, according to a preferred embodiment the end 100C is made in one piece with the diaphragm 8C and the slider 9C by moulding the elastomer material.

In such a case, the elastomer material may be overmoulded together with the insert 70C: this avoids the necessity of assembling separate parts consisting of the actuation element 10C and the insert 70C; alternatively, the insert 70C may be mounted onto the actuation element 10C.

It must however be pointed out that the end 100C may nonetheless be obtained separately from the rest of the actuation element 10C; for example, said end 100C may be manufactured by using a different elastomer independent of that of the slider 9C or diaphragm 8C, and associated with or mounted or overmoulded onto the insert 70C.

In this respect, it should also be pointed out that in this case the electric contact bridge 6C is connected to the insert 70C through a small hook visible in FIG. 15, similarly to the preceding examples.

Of course, the single features of the example shown in FIGS. 1-8 and those of the variants shown in FIGS. 9-13 may be combined together in order to create different switches other than those illustrated herein by way of non-limiting example.

An example of these possible combinations is shown in FIGS. 14, 15 and 16, wherein the same reference numerals designate, followed by the letter “D”, components equivalent to those of the above-described switch.

In practice, this variant is obtained by combining some features of the actuation element of the variant of FIGS. 9 and 10 with other features of the same element in accordance with the variants of FIGS. 13 and 14: therefore, for clarity, the above statements will apply as regards the features common to the examples shown in such figures, and vice versa the following description will apply to and complete the previous explanations.

Likewise, FIGS. 15 and 16 may be used as a complement to FIGS. 9, 10, 13 and 14, and vice versa.

Therefore, in this case the actuation element 10D that comprises the slider 9D features means for limiting the deformation of the latter, such means consisting of the rigid radial ribs 12D, i.e. a rigid element 12D co-moulded with and/or at least partly mounted internally to the elastomer element 10D.

If said rigid element or ribs 12D are made of thermoplastic material, it is preferable to use polyamide (PA) or polyparaphenylene sulphide (PPS), possibly charged with suitable reinforcement materials or fibres, such as fibreglass or the like; among these, it is most preferable to use PA66.

Alternatively, the limiting means may be made of metal or metal alloys; in such a case, it is preferable to use a metallic material which can be easily worked or moulded into complex shapes, e.g. by die casting, sintering, drawing or hot pressing.

In this variant of the invention, similarly to the previous one, the actuation element has one end 100D which protrudes from the diaphragm 8D and extends towards the lower half-shell 2D″.

The end 100D then extends past the insert 70D along the central axis of the switch, down to the lower half-shell 2D″: it is therefore so shaped as to provide the elastic means for resetting the electric contact, as a substitute for the spring 11 of the example of FIG. 1.

For this purpose, the end 100D is at least partly made of elastomer material; in addition, according to a preferred embodiment the end 100D is made in one piece with the diaphragm 8D and the slider 9D by moulding the elastomer material.

In such a case, the latter may be overmoulded together with the insert 70D: this avoids the necessity of assembling separate parts consisting of the actuation element 10D and the insert 70D.

It must however be pointed out that the end 100D may nonetheless be obtained separately from the rest of the actuation element 10D; for example, said end 100D may be manufactured by using a different elastomer independent of that of the slider 9D or diaphragm 8D, and associated with or mounted or overmoulded onto the insert 70D.

In this respect, it should also be pointed out that in this case as well the electric contact bridge 6D is connected to the insert 70D through a small hook visible in FIG. 15, similarly to the preceding examples.

Finally, it is also necessary to point out an improvement of the means 12 for limiting the deformation of the actuation element 10, which means have a cylindrical configuration like those of the example shown in FIG. 1.

This improvement is shown in detail in FIGS. 17 and 18, wherein the former only illustrates the limiting cylinder 120, which in this case is provided with a circular-crown base 121 that rests on the diaphragm 8 when the cylinder 120 is applied onto the slider 9, as shown in FIG. 18.

This solution offers the advantage that it prevents the diaphragm 8 from suffering any damage caused by the cylinder 120, since the base 121 is a support surface which has no edges that may cut the elastomer of the diaphragm.

In accordance with the preferred embodiment, the limiting cylinder 120 is obtained from a metal sheet bent and shaped by matching the ends thereof, which define a junction line 123 along a generatrix of the cylinder and the base 121.

Said junction line 123 may advantageously be gapped, thus providing, together with the grooves 124, 125 and 126 on the outer surface of the cylinder 120 and of the base 121, passages for the lubricant (typically oil) present between the cylinder 120 and the upper half-shell 2′ of the switch body (referring to the designations used in the first example of FIGS. 1-8).

In fact, due to the axial movements of the limiting cylinder 120, some liquid lubricant may remain trapped within the meatus comprised between the cylinder itself and the switch body, thus determining a certain dynamic pressure which may interfere with the motion of the cylinder, or the risk of infiltrations of lubricant into the region of the electric contacts.

The junction line 123 and/or the grooves 124-126 allow the liquid lubricant to flow out, thus preventing the formation of harmful accumulations.

It must however be remarked that this effect is also provided when rigid limiting means such as the radial ribs 12A (or 12D) are used, which define lubricant drain passages in the elastomerless portion between the raised ribs.

As a matter of fact, the presence of the rigid cross-like element with appropriately sized ribs 12A (or 12D), i.e. ribs raised suitably to prevent the elastomer of the central portion 9A′″ (or 9D′″) of the slider 9A (or 9D) from touching the walls of the body 2A (or 2D) if deformation occurs, ensures the presence of a number of axial passages.

Considering that said elastomer material typically adheres to the rigid material over which it is moulded, i.e. the cross-like ribs 12A (or 12D), even in the worst case of radial deformation of the compressed elastomer such deformation will only occur in the central portion of the region between two ribs, not in the region near the ribs, since the elastomer is attached thereto and cannot expand radially, thus leaving some axial passages.

The single features of the embodiments described so far may also be combined together in order to create switches other than those shown herein by way of non-limiting example.

All such variants obtainable from such combinations define inventive features and/or fall within the scope of the following claims.

1. Switch for vehicles, in particular of the type adapted to be actuated by a linkage or kinematic system of the vehicle, used for signaling an operating condition, comprising:
a body,
electric terminals housed within said body,
an actuation element at least partly movable within said body when subjected to a control action, so as to put at least two of said electric terminals in electric contact with each other,
characterized in that
said actuation element is at least partly deformable when a higher stress is applied thereto than necessary for closing the contact between the electric terminals.

2. Switch according to claim 1, wherein said actuation element (8-10; 8A-10A; 8B-10B; 8C-10C; 8D-10D) comprises at least one deformable portion (9′-9′″; 9A′-9A′″; 9B′; 9C′-9C′″; 9D′-9D′″) made of elastomer.

3. Switch according to claim 2, wherein said actuation element comprises at least one slider which is linearly movable within a slide guide obtained in said body.

4. Switch according to claim 1, wherein said actuation element is provided in monolithic form or in one piece with said at least partly deformable portion.

5. Switch according to claim 1, wherein at least one expansion chamber is obtained between said actuation element and said body for allowing said actuation element to become at least partly deformed, in particular without touching said body in the region of said expansion chamber.

6. Switch according to claim 1, wherein said actuation element comprises rigid means, in particular rigid means for at least partly limiting the deformation of the actuation element, such as means adapted to limit said deformation in a direction substantially transversal to the direction in which said actuation element moves within said body.

7. Switch according to claim 6, wherein said rigid means are adapted to operate as guide means.

8. Switch according to claim 6, wherein said rigid means comprise at least one raised portion or radial rib preferably integrated with said actuation element.

9. Switch according to claim 6, wherein said rigid means comprise a perimetric limiting element at least partly surrounding said actuation element.

10. Switch according to claim 6, wherein said expansion chamber is at least partly defined by the walls of said perimetric limiting element or raised portion.

11. Switch according to claim 6, wherein the limiting means comprise a cylinder with a circular-crown base at one end.

12. Switch according to claim 6, wherein the limiting means provide or comprise means for allowing liquid lubricant to flow, such as passages or grooves, junction lines and the like.

13. Switch according to claim 1, wherein the actuation element comprises at least one deformable portion obtained from a moulded elastomer.

14. Switch according to claim 13, wherein at least one portion of the elastomer is moulded onto or with said rigid limiting means.

15. Switch according to claim 1, wherein the body comprises two assembleable half-shells, within one of which said electric terminals are accommodated, and wherein a sealing diaphragm is provided at the interface between said two half-shells.

16. Switch according to claim 1, wherein the actuation element comprises a diaphragm obtained in one piece with the portion that forms the slider of the actuation element.

17. Switch according to claim 16, wherein the actuation element comprises a portion or end adapted to deform elastically for resetting the electric contact.

18. Switch according to claim 17, wherein the portion or end, the diaphragm and the slider are manufactured as one piece by using moulded elastomer material.
